(19) United States
(12) Patent Application Publication
(10) Pub. No.: US 2025/0200981 A1
(43) Pub. Date: Jun. 19, 2025

(54) IMAGE PROCESSING APPARATUS, SYSTEM, METHOD, AND COMPUTER-READABLE MEDIUM

(71) Applicant: NEC Corporation, Minato- ku, Tokyo (JP)

(72) Inventors: Shintaro CHIKU, Tokyo (JP); Naoko FUKUSHI, Tokyo (JP); Masanori KUKI, Tokyo (JP); Shuei YAMADA, Tokyo (JP); Shuhei MIZUGUCHI, Tokyo (JP); Kosei KOBAYASHI, Tokyo (JP)

(73) Assignee: NEC Corporation, Minato- ku, Tokyo (JP)

(21) Appl. No.: 18/843,345

(22) PCT Filed: Mar. 17, 2022
(86) PCT No.: PCT/JP2022/012277

§ 371 Date: Sep. 3, 2024

(51) Int. Cl. G06V 20/56

(52) U.S. Cl. CPC G06V 20/56

(57) ABSTRACT

In a first server, reception means receives an image acquired by using an imaging device. Processing means performs first image processing on the image received by the reception means. Transmission means transmits the image on which the first image processing has been performed by the processing means to the second server. A second server performs second image processing on the image received from the first server.

### TECHNICAL FIELD

The present disclosure relates to image processing apparatus, system, method, and a computer-readable medium.

### BACKGROUND ART

As a related art, Patent Literature 1 discloses a data processing system. The data processing system described in Patent Literature 1 includes a high-speed response processing apparatus and a real-time processing apparatus. The high-speed response processing apparatus receives an in-vehicle camera image and control area network (CAN) data from a vehicle. The high-speed response processing apparatus detects an object from the in-vehicle camera image. The high-speed response processing apparatus transmits presence or absence of an obstacle, a type of the obstacle, and an approximate position of the obstacle to the real-time processing apparatus. The real-time processing apparatus estimates an accurate position of the obstacle based on the in-vehicle camera image, the CAN data, and a detection result in the high-speed response processing apparatus.

### CITATION LIST

### Patent Literature

Patent Literature 1: International Patent Publication No. WO2021/100087

### SUMMARY OF INVENTION

### Technical Problem

A system that transmits a camera image from various vehicles to a server and performs image analysis on the server is conceivable. In this case, brightness, an angle of view, and the like of the camera image may be different for each camera image depending on the vehicles and a surrounding environment. In this case, in the image analysis performed on the server, an individual difference of the camera image may be an obstacle to the analysis. Patent Literature 1 only discloses estimating an approximate position of an obstacle in a high-speed response processing apparatus, and estimating an accurate position of the obstacle in a real-time processing apparatus.

In view of the above circumstances, an object of the present disclosure is to provide an image processing apparatus, an image processing system, an image processing method, and a computer-readable medium capable of performing predetermined image processing on a server without depending on an image acquired from an imaging device.

### Solution to Problem

In order to achieve the above-described object, the present disclosure provides an image processing apparatus as a first aspect. The image processing apparatus includes: reception means for receiving an image acquired by using an imaging device; processing means for performing first image processing on the received image; and transmission means for transmitting the image on which the first image processing has been performed to a server configured to perform second image processing on the image on which the first image processing has been performed.

The present disclosure provides an image processing system as a second aspect. The image processing system includes: one or more first servers that perform first image processing on an image acquired by using an imaging device; and a second server that receives an image on which the first image processing has been performed from the first server and performs second image processing on the received image. The first server includes reception means for receiving an image acquired by using the imaging device, processing means for performing the first image processing on the received image, and transmission means for transmitting the image on which the first image processing has been performed to the second server.

The present disclosure provides an image processing method as a third aspect. The image processing method includes: receiving an image acquired by using an imaging device; performing first image processing on the received image; and transmitting the image on which the first image processing has been performed to a server that performs second image processing on the image on which the first image processing has been performed.

The present disclosure provides a computer-readable medium as a fourth aspect. The computer-readable medium stores a program for causing a computer to execute processing including: receiving an image acquired by using an imaging device; performing first image processing on the received image; and transmitting an image on which first image processing has been performed to a server configured to perform second image processing on the image on which the first image processing has been performed.

### Advantageous Effects of Invention

The image processing apparatus, the image processing system, the image processing method, and the computer-readable medium according to the present disclosure can perform predetermined image processing on a server without depending on an image acquired from an imaging device.

### BRIEF DESCRIPTION OF DRAWINGS

FIG. 1 is a block diagram illustrating a schematic configuration of an image processing system according to the present disclosure.

FIG. 2 is a block diagram illustrating an image processing system according to an example embodiment of the present disclosure.

FIG. 3 is a block diagram illustrating a configuration example of an L-MEC server.

FIG. 4 is a sequence diagram illustrating an operation procedure of the image processing system.

FIG. 5 is a block diagram illustrating an image processing system according to a modified example.

FIG. 6 is a block diagram illustrating a configuration example of a computer apparatus.

### EXAMPLE EMBODIMENT

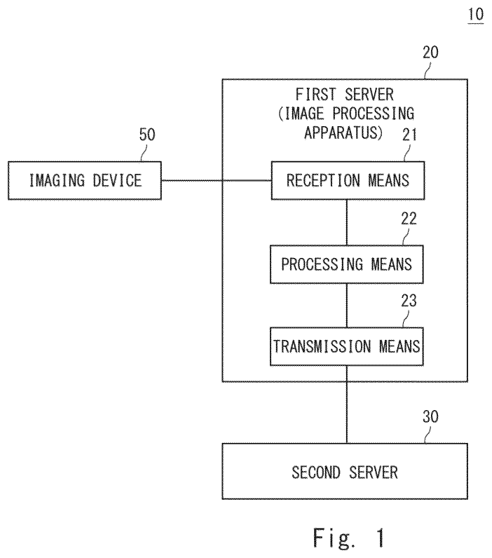

Prior to describing an example embodiment of the present disclosure, an outline of the present disclosure will be described. FIG. 1 illustrates a schematic configuration of an image processing system according to the present disclosure. An image processing system 10 includes a first server 20 and a second server 30. The first server 20 performs first image processing on an image acquired by using an imaging device 50. The first server 20 is configured as an image processing apparatus. The image processing system 10 may have a plurality of the first servers 20.

The first server 20 includes reception means 21, processing means 22, and transmission means 23. The reception means 21 receives an image acquired by using the imaging device 50. Note that, only one imaging device 50 is illustrated in FIG. 1, but the number of imaging devices 50 is not limited to one. The reception means 21 may receive images from a plurality of the imaging devices 50.

The processing means 22 performs first image processing on the image received by the reception means 21. The transmission means 23 transmits the image subjected to the first image processing by the processing means 22 to the second server 30. The second server 30 receives the image subjected to the first image processing from the first server 20. The second server 30 performs second image processing on the image received from the first server 20.

In the present disclosure, in the first server 20, the processing means 22 performs first image processing on an image acquired by using the imaging device 50. The second server 30 performs second image processing on the image on which the first image processing has been performed. In the present disclosure, the image on which the second server 30 performs the second image processing is subjected to the first image processing in the first server 20. In a case where appropriate processing is performed as the first image processing in the first server 20, the second server 30 can perform the second image processing without depending on the image acquired from the imaging device 50. For example, the first server 20 performs processing for reducing an individual difference of an image as first image processing. In this case, the second server 30 can perform the second image processing without being conscious of the individual difference of the image.

Hereinafter, example embodiments according to the present disclosure will be described in detail with reference to the drawings. Note that, in the description and drawings to be described below, omission and simplification are made as appropriate, for clarity of description. In addition, in each of the drawings described below, the same elements and similar elements are denoted by the same reference signs, and a duplicate description is omitted as necessary.

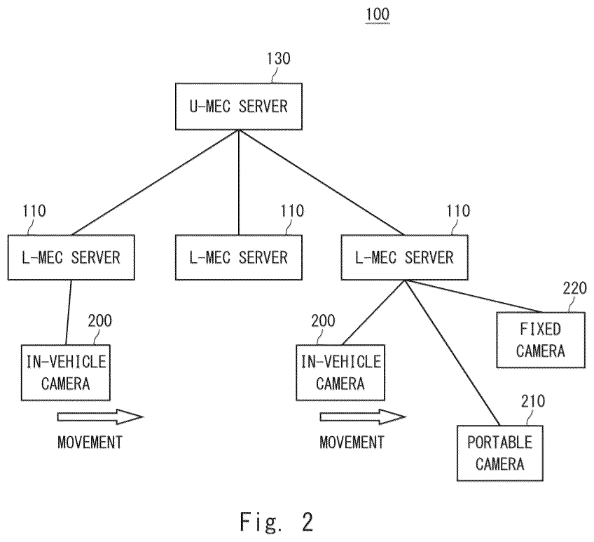

FIG. 2 illustrates an image processing system according to an example embodiment of the present disclosure. The image processing system includes a plurality of servers 110 and a server 130. Hereinafter, each of the server 110 is also referred to as a lower-multi-access/mobile edge computing (L-MEC) server. The server 130 is also referred to as an upper-MEC (U-MEC) server. Each of the L-MEC server 110 and the U-MEC server 130 includes, for example, one or more processors and one or more memories. At least some of functions of respective units in the L-MEC server 110 and the U-MEC server 130 can be realized by the processor executing processing according to a program read from a memory.

The L-MEC server 110 receives a video or an image captured by using a camera from at least one of an in-vehicle camera 200, a portable camera 210, and a fixed camera 220. The in-vehicle camera 200 is a camera mounted on a mobile body. One mobile body may be equipped with a plurality of the in-vehicle cameras 200 having different imaging directions. The mobile body is configured as, for example, a land vehicle such as an automobile, a two-wheeled vehicle, a bus, a taxi, or a truck. Further, the mobile body may be a train, a ship, or an aircraft, or may be a mobile robot such as an automated guided vehicle (AGV). The mobile body may be configured so as to be able to perform automated driving or autonomous driving based on information from a sensor disposed in the mobile body. Each of the in-vehicle camera 200 captures, for example, an image of the outside of the mobile body. For example, the in-vehicle camera 200 may be a camera that captures an image in a traveling direction of the mobile body. Alternatively, the in-vehicle camera 200 may be a camera that captures an image of the inside of the mobile body.

The portable camera 210 is a camera that can be carried around. An operator can install the portable camera 210 at a desired location. The portable camera 210 is installed, for example, at a place where a vehicle traveling on a road can be imaged. The location where the portable camera 210 is installed can be changed according to time. The fixed camera 220 is a camera whose installation place is fixed. The fixed camera 220 is installed at, for example, an intersection, a traffic light, or a utility pole. The fixed camera 220 captures an image of, for example, a vehicle traveling on a road. Each of the in-vehicle camera 200, the portable camera 210, and the fixed camera 220 corresponds to the imaging device 50 illustrated in FIG. 1.

The L-MEC server 110 receives images from the in-vehicle camera 200, the portable camera 210, and the fixed camera 220 via a network. The network may include, for example, a wireless communication network using a communication line standard such as a fourth generation mobile communication system or long term evolution (LTE). The network may include a wireless communication network such as WiFi (registered trademark) or 5th Generation (5G) mobile communication system or local 5G. The image received by the L-MEC server 110 may be a moving image or a still image.

Each of the L-MEC servers 110 is disposed, for example, in correspondence with a base station of a wireless communication network. For example, the L-MEC server 110 is connected to a base station in the 5G wireless communication network, i.e. a next generation NodeB (gNB), via a user plane function (UPF). Each base station is connected to a 5th generation core network (5GC) via the UPF. The 5GC may be connected to an external network.

A mobile body or a communication apparatus mounted on the mobile body is connected to a communicable base station among a plurality of base stations. The in-vehicle camera 200 transmits an image to the L-MEC server 110 corresponding to the base station to which the mobile body is connected. In addition, the portable camera 210 is connected to a communicable base station among the plurality of base stations. The portable camera 210 transmits an image to the L-MEC server 110 corresponding to the connected base station. The fixed camera 220 transmits an image to, for example, the L-MEC server 110 at a geographically closest location. The fixed camera 220 may transmit an image to the L-MEC server 110 via a wireless network, or may transmit the image to the L-MEC server 110 via a wired network.

The L-MEC server 110 performs first image processing on the received image. The L-MEC server 110 transmits the image on which the first image processing has been performed to the U-MEC server 130. The U-MEC server 130 is a server of a higher layer that supervises the plurality of L-MEC servers 110. The U-MEC server 130 may be a server connected to the 5GC or a server connected to an external network such as a cloud server. In the present example embodiment, the L-MEC server 110 corresponds to the first server 20 illustrated in FIG. 1. The U-MEC server 130 corresponds to the second server 30 illustrated in FIG. 1.

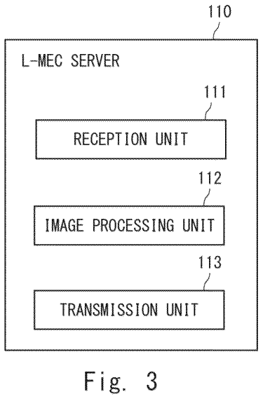

FIG. 3 illustrates a configuration example of the L-MEC server 110. The L-MEC server 110 includes a reception unit 111, an image processing unit 112, and a transmission unit 113. The reception unit 111 receives an image from at least one of the in-vehicle camera 200, the portable camera 210, and the fixed camera 220. The reception unit 111 may receive images from the plurality of in-vehicle cameras 200. Furthermore, the reception unit 111 may receive images from a plurality of the portable cameras 210 or may receive images from a plurality of the fixed cameras 220. The reception unit 111 corresponds to the reception means 21 illustrated in FIG. 1.

Image processing unit 112 performs first image processing on the image received by the reception unit 111. The first image processing includes, for example, image correction processing such as calibration. The first image processing may include, for example, processing of adjusting an image acquired by using each of the plurality of cameras in conformity to a predetermined standard. For example, the image processing unit 112 may correct the image so that at least one of an angle of view and brightness of the image meets the predetermined standard. The image processing unit 112 may correct the image so that the angle of view meets the predetermined standard by changing an image range and a viewpoint position of the image. The correction processing may be defined in correspondence with a type of a camera, for example, in correspondence with an image of the in-vehicle camera 200, an image of the portable camera 210, and an image of the fixed camera 220.

For example, in the first image processing, the image processing unit 112 may correct the received image in correspondence with a transmission source of the image. For example, the image processing unit 112 may correct the image of the in-vehicle camera 200 by using the vehicle information of the mobile body that has transmitted the image. The vehicle information may include, for example, information such as a size of a vehicle body and a vehicle type. For example, the image processing unit 112 may correct images so that each of the images of the plurality of in-vehicle cameras 200, which are received from a plurality of mobile bodies, becomes an image captured at the same angle of view from the same viewpoint. The image processing unit 112 may correct the image in correspondence with time when the image is acquired.

The image processing unit 112 may correct an influence of weather in the image in the first image processing. For example, in a case where haze occurs, the image processing unit 112 may perform correction to remove haze from the image. The image processing unit 112 may acquire sensor information of an environment sensor in a place where the image is captured, and correct the image by using the acquired sensor information. The environment sensor includes, for example, sensors such as a sunshine recorder and a rain gauge. The image processing unit 112 may acquire weather information as sensor information from an external server that provides the weather information, and correct the image by using the acquired weather information. The first image processing may include processing of compressing an image. The image processing unit 112 corresponds to the processing means 22 illustrated in FIG. 1.

The transmission unit 113 transmits the image on which the first image processing has been performed by the image processing unit 112 to the U-MEC server 130 that is a server of a higher layer. For example, the transmission unit 113 transmits an image in which viewpoints and angles of view are unified when the image processing unit 112 performs correction processing on images captured by using the plurality of in-vehicle cameras 200 to the U-MEC server 130. The transmission unit 113 corresponds to the transmission means 23 illustrated in FIG. 1.

The U-MEC server 130 receives the image on which the first image processing has been performed and which has been transmitted by the transmission unit 113 of the L-MEC server 110. The U-MEC server 130 receives the image on which the first image processing has been performed from a plurality of the L-MEC servers 110. It is assumed that the plurality of L-MEC servers 110 perform correction processing of the same content. In this case, for example, with respect to images of the plurality of in-vehicle cameras 200, even in a case where the images transmitted from mobile bodies are not unified, the U-MEC server 130 can receive the images in which an individual difference for each mobile bodies is eliminated.

The U-MEC server 130 performs second image processing on the received images. The second image processing includes, for example, image analysis processing. The U-MEC server 130 analyzes whether or not a dangerous situation occurs in a mobile body, a bicycle, or a pedestrian, for example, in the image analysis processing. When the U-MEC server 130 receives the images on which the image processing for eliminating the individual difference is performed in the L-MEC servers 110, the U-MEC server 130 can perform the image analysis processing without being conscious of the individual difference for each of the images. Therefore, the U-MEC server 130 can perform image analysis processing by utilizing videos of each of the in-vehicle cameras 200 which are transmitted from a plurality of mobile bodies.

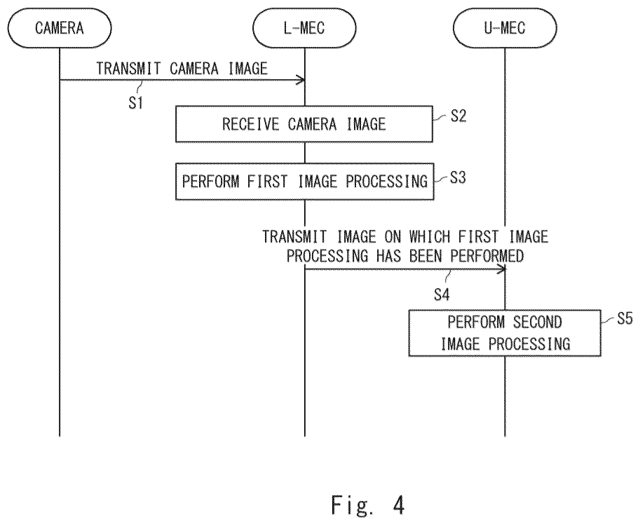

Next, an operation procedure will be described. FIG. 4 illustrates an operation procedure of the image processing system 100. The in-vehicle camera 200, the portable camera 210, or the fixed camera 220 transmits an image to the L-MEC server 110 (step S1). In the L-MEC server 110, the reception unit 111 receives the camera image transmitted in step S1 (step S2).

The image processing unit 112 performs first image processing on the camera image received in step S2 (step S3). In step S3, for example, the image processing unit 112 corrects the camera image so that the camera image conforms to a predetermined standard. The transmission unit 113 transmits the image on which the first image processing has been performed in step S3 to the U-MEC server 130 (step S4). Steps S2 to S4 correspond to an image processing method implemented in the L-MEC server 110.

The U-MEC server 130 performs second image processing on the camera image received from the L-MEC server 110 (step S5). In step S5, the U-MEC server 130 performs, for example, image analysis processing on the camera image. The U-MEC server 130 may transmit a result of the second image processing to an image transmission source such as a mobile body. Alternatively, the U-MEC server 130 may transmit the result of the second image processing to a mobile body traveling around the image transmission source.

In the present example embodiment, the image processing system 100 includes the L-MEC servers 110 and the U-MEC server 130. Each of the L-MEC server 110 performs correction processing or the like on the camera image, and transmits the corrected camera image to the U-MEC server 130 of an upper layer. In this way, for example, even in a case where the viewpoint and the angle of view of the camera image transmitted from the in-vehicle camera 200 are different for each mobile body, the U-MEC server 130 can perform the image analysis processing without being conscious of the difference in the viewpoint and the angle of view. In a case where the correction process has been set to be performed in the U-MEC server 130, the U-MEC server 130 performs the correction process in addition to the image analysis processing, and the processing load increases. In the present example embodiment, since the correction processing is performed in a server of a lower layer and the corrected camera image is transmitted to a server of an upper layer, the processing load of the server of the upper layer can be reduced.

In the present example embodiment, the L-MEC server 110 can correct the camera image to an image requested by the U-MEC server 130. When specifications of the image used by the U-MEC server 130 for the image analysis processing are changed, the correction processing performed by the L-MEC server 110 may be changed in correspondence with the changed specifications. By changing the correction process, the L-MEC server 110 can transmit the image of the changed specifications to the U-MEC server 130. In the present example embodiment, since the image requested by the U-MEC server 130 can be generated by the L-MEC server 110, it is not necessary to change the camera image transmitted from the in-vehicle camera 200 even in a case where the specifications of the image used for the image analysis processing are changed.

Note that, in the above-described example embodiment, an example has been described in which the image processing system 100 includes one set of one or more first servers and one or more second servers. However, the present disclosure is not limited thereto. The image processing system may include a plurality of sets of one or more first servers and second servers.

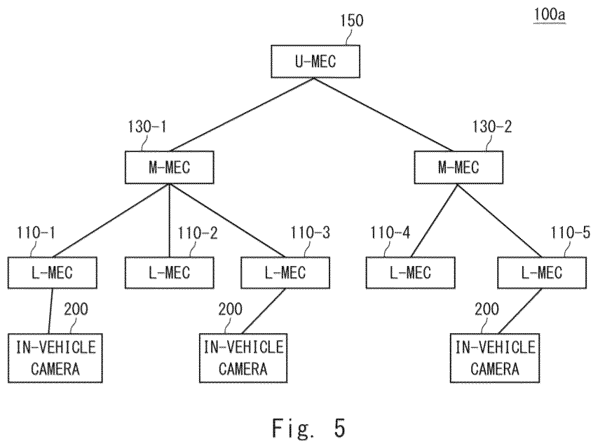

FIG. 5 illustrates an image processing system according to a modified example. An image processing system 100a according to this modified example includes a plurality of servers 110-1 to 110-5, a plurality of servers 130-1 and 130-2, and a server 150. Note that, in the following description, the servers 110-1 to 110-5 and the servers 130-1 and 130-2 are also referred to as servers 110 and a server 130, respectively, in a case where it is not particularly necessary to distinguish them.

In the image processing system 100a, each of the servers 110 corresponding to the first server is an MEC server in a lower layer or an L-MEC server. The server 130 corresponding to the second server is an MEC server in a middle layer or a middle-MEC (M-MEC) server. The server 150 corresponding to the third server is an MEC server in an upper layer or a U-MEC server. In this modified example, the L-MEC server 110 corresponds to the L-MEC server 110 illustrated in FIG. 2, and the M-MEC server 130 corresponds to the U-MEC server 130 illustrated in FIG. 2.

The image processing system 100a includes two sets of the L-MEC server 110 and the M-MEC server 130. In the image processing system 100a, the M-MEC server 130-1 receives images on which the first image processing has been performed from the L-MEC servers 110-1 to 110-3. The M-MEC server 130-1 performs second image processing on the received images. The M-MEC server 130-2 receives images on which the first image processing has been performed from the L-MEC servers 110-4 and 110-5. The M-MEC server 130-2 performs second image processing on the received images.

It is assumed that details of the first image processing are defined for each set of the L-MEC server 110 and the M-MEC server 130. The first image processing performed by the L-MEC servers 110-1 to 110-3 and the first image processing performed by the L-MEC servers 110-4 and 110-5 are not necessarily the same. In addition, the second image processing performed by the M-MEC server 130 and the second image processing performed by the M-MEC server 130-2 are not necessarily the same. Each of the L-MEC servers 110 may perform the first image processing in accordance with required specifications of an input image of the second image processing performed by the M-MEC server 130 of an image transmission destination.

In the image processing system 100a, the U-MEC server 150 receives results of the second image processing from the M-MEC servers 130-1 and 130-2. The U-MEC server 150 receives, for example, results of image analysis processing from the plurality of M-MEC servers 130. The U-MEC server 150 aggregates, for example, the received results of the image analysis processing. The U-MEC server 150 stores the aggregated result of the image analysis processing in a database or the like. Alternatively, the U-MEC server 150 may transmit the aggregated result of the image analysis processing to the mobile body.

In the above-described example embodiment and modified example, an example in which the L-MEC server is the first server that performs the first image processing and the U-MEC server or the M-MEC server is the second server that performs the second image processing has been described. However, the present disclosure is not limited thereto. In the present disclosure, each of the first image processing and the second image processing may be performed by using servers of a plurality of layers. In other words, the function of the first server may be implemented in servers of a plurality of layers, or the function of the second server may be implemented in servers of a plurality of layers.

For example, in FIG. 5, the L-MEC server 110 and the M-MEC server 130 may correspond to a first server that performs the first image processing, and the U-MEC server 150 may correspond to a second server that performs the second image processing. Alternatively, the L-MEC server 110 may correspond to the first server that performs the first image processing, and the M-MEC server 130 and the U-MEC server 150 may correspond to the second server that performs the second image processing.

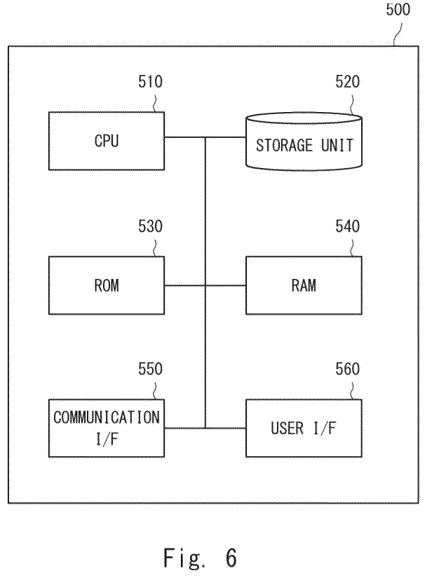

Next, hardware configurations of the L-MEC server 110 and the U-MEC server 130 used as image processing apparatuses will be described. FIG. 6 illustrates a configuration example of a computer apparatus that can be used for the L-MEC server 110 and the U-MEC server 130. A computer apparatus 500 includes a control unit (CPU) 510, a storage unit 520, a read only memory (ROM) 530, a random access memory (RAM) 540, a communication interface (IF) 550, and a user interface 560.

The communication interface 550 is an interface for connecting the computer apparatus 500 to a communication network through wired communication means, wireless communication means, or the like. The user interface 560 includes, for example, a display unit such as a display. Further, the user interface 560 includes an input unit such as a keyboard, a mouse, and a touch panel.

The storage unit 520 is an auxiliary storage device that can hold various types of data. The storage unit 520 is not necessarily a part of the computer apparatus 500, and may be an external storage device or a cloud storage connected to the computer apparatus 500 via a network.

The ROM 530 is a nonvolatile storage device. For example, a semiconductor storage device such as a flash memory having a relatively small capacity may be used for the ROM 530. A program that is executed by the CPU 510 may be stored in the storage unit 520 or the ROM 530. The storage unit 520 or the ROM 530 stores, for example, various programs for realizing functions of each unit of the L-MEC server 110 or the U-MEC server 130.

The program described above includes a group of commands or software codes for causing a computer to perform one or more functions described in the example embodiment when being read by the computer. The program may be stored in a non-transitory computer-readable medium or a tangible storage medium. As an example and not by way of limitation, a computer-readable medium or tangible storage medium includes a RAM, a ROM, a flash memory, a solid-state drive (SSD) or other memory technique, a compact disc (CD), a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer-readable medium or a communication medium. As an example and not by way of limitation, the transitory computer-readable medium or the communication medium includes an electrical signal, an optical signal, an acoustic signal, or other forms of propagation signals.

The RAM 540 is a volatile storage device. As the RAM 540, various types of semiconductor memory devices such as a dynamic random access memory (DRAM) or a static random access memory (SRAM) may be used. The RAM 540 may be used as an internal buffer for temporarily storing data or the like. The CPU 510 loads a program stored in the storage unit 520 or the ROM 530, in the RAM 540, and executes the loaded program. Functions of the respective units in the server can be realized by the CPU 510 executing the program. The CPU 510 may include an internal buffer in which data or the like can be temporarily stored.

Although example embodiments according to the present disclosure have been described above in detail, the present disclosure is not limited to the above-described example embodiments, and the present disclosure also includes those that are obtained by making changes or modifications to the above-described example embodiments without departing from the gist of the present disclosure. For example, the matters described in the above-described example embodiment can be appropriately combined.

For example, a portion or the entirety of the above-described example embodiment may be described as the following Supplementary Notes, but are not limited to the following.

### [Supplementary Note 1]

An image processing apparatus including:
reception means for receiving an image acquired by using an imaging device;
processing means for performing first image processing on the received image; and
transmission means for transmitting the image on which the first image processing has been performed to a server configured to perform second image processing on the image on which the first image processing has been performed.

### [Supplementary Note 2]

The image processing apparatus according to Supplementary Note 1, wherein the first image processing includes image correction processing.

### [Supplementary Note 3]

The image processing apparatus according to Supplementary Note 2, wherein the processing means corrects the received image by using sensor information of an environment sensor in the correction processing.

### [Supplementary Note 4]

The image processing apparatus according to Supplementary Note 2 or 3, wherein the processing means corrects the received image in correspondence with a transmission source of the image in the correction processing.

### [Supplementary Note 5]

The image processing apparatus according to any one of Supplementary Notes 1 to 4, wherein the reception means receives an image acquired from a mobile body by using an imaging device mounted on the mobile body.

### [Supplementary Note 6]

The image processing apparatus according to Supplementary Note 5, wherein the processing means performs the first image processing by using vehicle information of a mobile body that is a transmission source of the received image.

### [Supplementary Note 7]

The image processing apparatus according to any one of Supplementary Notes 1 to 6, wherein the reception means receives an image acquired by using each of a plurality of imaging devices from the plurality of imaging devices.

### [Supplementary Note 8]

The image processing apparatus according to Supplementary Note 7, wherein the first image processing includes processing of adjusting an image acquired by using each of the plurality of imaging devices in conformity to a predetermined standard.

### [Supplementary Note 9]

An image processing system including:
one or more first servers configured to perform first image processing on an image acquired by using an imaging device; and
a second server configured to receive an image on which the first image processing has been performed from the first servers, and to perform second image processing on the received image, wherein
the first server includes,
reception means for receiving an image acquired by using the imaging device,
processing means for performing first image processing on the received image, and
transmission means for transmitting the image on which the first image processing has been performed to the second server.

### [Supplementary Note 10]

The image processing system according to Supplementary Note 9, wherein
the first image processing includes image correction processing, and
the second image processing includes image analysis processing.

### [Supplementary Note 11]

The image processing system according to Supplementary Note 10, wherein the processing means corrects the received image by using sensor information of an environment sensor in the correction processing.

### [Supplementary Note 12]

The image processing system according to Supplementary Note 10 or 11, wherein the processing means corrects the received image in correspondence with a transmission source of the image in the correction processing.

### [Supplementary Note 13]

The image processing system according to any one of Supplementary Notes 9 to 12, wherein the first server is a multi-access/mobile edge computing (MEC) server.

### [Supplementary Note 14]

The image processing system according to any one of Supplementary Notes 9 to 13, wherein
a plurality of the first servers are provided, and
the second server receives an image on which the first image processing has been performed from the plurality of first servers.

### [Supplementary Note 15]

The image processing system according to any one of Supplementary Notes 9 to 14, wherein
a plurality of sets of the plurality of first servers and a plurality of the second servers are provided, and
a third server configured to receive a result of the second image processing from the second servers in the plurality of sets is further provided.

### [Supplementary Note 16]

The image processing system according to any one of Supplementary Notes 9 to 15, wherein the second server is a server of a higher layer that supervises the one or more first servers.

### [Supplementary Note 17]

An image processing method in an image processing apparatus, the method including:
receiving an image acquired by using an imaging device;
performing first image processing on the received image; and
transmitting the image on which the first image processing has been performed to a server configured to perform second image processing on the image on which the first image processing has been performed.

### [Supplementary Note 18]

A non-transitory computer-readable medium storing a program for causing a computer to execute processing including:
receiving an image acquired by using an imaging device;
performing first image processing on the received image; and
transmitting an image on which first image processing has been performed to a server configured to perform second image processing on the image on which the first image processing has been performed.

### REFERENCE SIGNS LIST

10 IMAGE PROCESSING SYSTEM
20 FIRST SERVER
21 RECEPTION MEANS
22 PROCESSING MEANS
23 TRANSMISSION MEANS
30 SECOND SERVER
50 IMAGING DEVICE
100 IMAGE PROCESSING SYSTEM
110, 130, 150 SERVER
111 RECEPTION UNIT
112 IMAGE PROCESSING UNIT
113 TRANSMISSION UNIT
200 IN-VEHICLE CAMERA
210 PORTABLE CAMERA
220 FIXED CAMERA
500 COMPUTER APPARATUS
510 CPU
520 STORAGE UNIT
530 ROM
540 RAM
550 COMMUNICATION INTERFACE
560 USER INTERFACE

What is claimed is:

1. An image processing apparatus comprising:
at least one memory storing instructions; and
at least one processor configured to execute the instructions to:
receive an image acquired by using a camera;
perform first image processing on the received image; and
transmit the image on which the first image processing has been performed to a server configured to perform second image processing on the image on which the first image processing has been performed.

2. The image processing apparatus according to claim 1, wherein the first image processing includes image correction processing.

3. The image processing apparatus according to claim 2, wherein the at least one processor is configured to execute the instructions to correct the received image by using sensor information of an environment sensor in the correction processing.

4. The image processing apparatus according to claim 2, wherein the at least one processor is configured to execute the instructions to correct the received image in correspondence with a transmission source of the image in the correction processing.

5. The image processing apparatus according to claim 1, wherein the at least one processor is configured to execute the instructions to receive an image acquired from a mobile body by using a camera mounted on the mobile body.

6. The image processing apparatus according to claim 5, wherein the at least one processor is configured to execute the instructions to perform the first image processing by using vehicle information of a mobile body that is a transmission source of the received image.

7. The image processing apparatus according to claim 1, wherein the at least one processor is configured to execute the instructions to receive an image acquired by using each of a plurality of cameras from the plurality of cameras.

8. The image processing apparatus according to claim 7, wherein the first image processing includes processing of adjusting an image acquired by using each of the plurality of cameras in conformity to a predetermined standard.

9. An image processing system comprising:
one or more first servers each comprising the image processing apparatus according to claim 1; and
a second server configured to receive an image on which the first image processing has been performed from the first servers, and to perform second image processing on the received image.

10. The image processing system according to claim 9, wherein
the first image processing includes image correction processing, and
the second image processing includes image analysis processing.

11. The image processing system according to claim 10, wherein the at least one processor is configured to execute the instructions to correct the received image by using sensor information of an environment sensor in the correction processing.

12. The image processing system according to claim 10, wherein the at least one processor is configured to execute the instructions to correct the received image in correspondence with a transmission source of the image in the correction processing.

13. The image processing system according to claim 9, wherein the first server is a multi-access/mobile edge computing (MEC) server.

14. The image processing system according to claim 9, wherein
a plurality of the first servers are provided, and
the second server receives an image on which the first image processing has been performed from the plurality of first servers.

15. The image processing system according to claim 9, wherein
a plurality of sets of the plurality of first servers and a plurality of the second servers are provided, and
a third server configured to receive a result of the second image processing from the second servers in the plurality of sets is further provided.

16. The image processing system according to claim 9, wherein the second server is a server of a higher layer that supervises the one or more first servers.

17. An image processing method in an image processing apparatus, the method comprising:
receiving an image acquired by using a camera;
performing first image processing on the received image; and
transmitting the image on which the first image processing has been performed to a server configured to perform second image processing on the image on which the first image processing has been performed.

18. A non-transitory computer-readable medium storing a program for causing a computer to execute processing including:
receiving an image acquired by using a camera;
performing first image processing on the received image; and
transmitting an image on which first image processing has been performed to a server configured to perform second image processing on the image on which the first image processing has been performed.
